(19) United States
(12) Patent Application Publication
(10) Pub. No.: US 2023/0192469 A1
(43) Pub. Date: Jun. 22, 2023

(54) Tap for Liquid Containment Containers

(71) Applicant: Pico Juan Milagros, Ibi (ES)

(72) Inventor: Pico Juan Milagros, Ibi (ES)

(21) Appl. No.: 18/085,556

(22) Filed: Dec. 20, 2022

(30) Foreign Application Priority Data
Dec. 20, 2021 (ES) U202132497

(51) Int. Cl. B67D 3/04; B65D 77/06

(52) U.S. Cl. CPC B67D 3/045; B65D 77/067

(57) ABSTRACT

A tap for packaging containing liquid, formed by a box and a containment bag situated therein, includes a body with a connection to the bag and an outlet mouth to the exterior in the bottom region thereof, and the interior of which comprises a tightly fitting patch for closing the outlet mouth and an elastic spring connected to the patch, and an opening device with lateral fins connected to the patch; the tap is provided with means for actuating the fins of the opening device, which includes a lever part, and a connection element for connecting the lever part to the body of the tap; wherein the tilting of the lever part causes the vertical displacement of the top ends of the side pieces, which in turn vertically displace the fins, causing the tap to open by removing the patch with respect to the outlet mouth.

### FIELD

The present invention corresponds to the technical field of packaging containing liquid, formed by a box and a containment bag situated therein, and specifically to an outlet tap connected to the bag with an opening device for opening by means of lateral fins.

### BACKGROUND

These days, packaging formed by a plastic bag containing the liquid, which is situated inside a cardboard box, is frequently used in order to contain liquids. This type of packaging is known as “bag in box” (BIB) packaging and is very useful for storing liquid substances in volumes suitable for personal, family and even professional use; these liquid substances can be dispensed in various doses, depending on the user’s requirements.

With this objective, this type of packaging usually has a tap which enables the user to open and close the outlet flow of the liquid at their convenience.

The model of tap that is most commonly used in this type of packaging, known in the sector by its trade name “Vitop”, is formed by a body that has a connection to the bag and an outlet mouth to the exterior in the bottom region thereof. Inside the body of the tap, the latter includes a patch for closing the outlet mouth and a rubber spring connected to the patch. One feature of this type of tap is that they also have an opening device with lateral fins connected to the patch.

The closure patch is thus naturally in the closure position thanks to the action of the spring, which pushes it downwards. In order to allow the passage of liquid, the patch has to be lifted by overcoming the force of the spring; this is achieved by using the thumb, ring finger and middle finger, pushing the two lateral fins of the opening device upwards.

When this action is no longer exerted, the spring automatically returns the patch to the closure position of the tap, cutting off the flow. Although this tap is actuated with just one hand, it is necessary to use the other hand to hold the glass or container that is intended to collect the emerging fluid, placing it below the outlet mouth.

As a result, the user’s movement is limited, since both hands have to be used for the same purpose. It is precisely the object of the present invention to provide a way of solving this drawback, achieving a tap that does not require the use of both hands.

### SUMMARY

The tap for packaging containing liquid presented here, for packaging formed by a box and a containment bag situated therein, comprises a body with a connection to the bag and an outlet mouth to the exterior in the bottom region thereof, and in the interior thereof it comprises a patch for closing the outlet mouth and a spring connected to the patch. The tap also comprises an opening device with lateral fins connected to the patch.

This tap also comprises means for actuating the fins of the opening device.

Said actuation means are formed by a lever part and a connection element for connecting the lever part to the body of the tap.

The lever part comprises two side pieces situated on both sides of the outlet mouth and a bottom end arranged between said outlet mouth and the packaging, with an elevation which is lower than that of the outlet mouth. In this way, in a closure position of the tap in which the patch is engaged in the outlet mouth thereof, each side piece has a top end close to one of the fins, and the bottom end has a horizontal separation distance with respect to the packaging. Likewise, the connection element for connecting the lever part to the body of the tap is attached to said body and comprises coupling means for coupling to both side pieces of the lever part. These coupling means are such that they form a tilting shaft for this lever part from the closure position of the tap to an opening position of the tap, wherein the separation distance of the bottom end of the lever part with respect to the packaging is less than in the closure position and the top end of the side pieces thereof is in contact with the corresponding fin, wherein these fins have an elevation which is greater than that of the closure position, such that the separation of the patch with respect to the outlet mouth is permitted.

A significant improvement of the prior art is obtained by means of the tap for packaging containing liquid proposed here.

A tap that can be opened using just one hand, the one holding the glass or container intended to be filled with liquid, is therefore achieved, since by simply pushing the lever part with the glass, the fins of the opening device are lifted and as a result the closure patch is lifted or separated with respect to the outlet mouth, thus allowing the tap to be opened and allowing the flow of the liquid contained therein.

This is possible by means of a simple tap comprising actuation means that allow the tap to be opened using just one hand, and furthermore also the option of coupling these actuation means to existing taps for this type of packaging is also possible, meaning that it can be used as first choice or else adapted to the taps which currently exist on the market, with it not being necessary to replace same and unnecessary costs are thereby avoided.

A tap which is very practical and efficient, which allows rapid and easy use with just one hand by the user, and which keeps their other hand free to use in any other way required therefore results.

### BRIEF DESCRIPTION OF THE DRAWINGS

In order to aid better understanding of the features of the invention, in accordance with one preferred practical embodiment of the invention, a series of drawings is provided as an integral part of said description, in which the following is represented by way of illustration and in a non-limiting manner:

FIGS. 1.1 and 1.2.- Show top and bottom perspective views, respectively, of a tap for packaging containing liquid, for a first preferred embodiment of the invention.

FIGS. 1.3 and 1.4.- Show top and bottom perspective views, respectively, of a tap for packaging containing liquid, for a variant of the first preferred embodiment of the invention.

FIG. 2A.- Shows an exploded view of a tap for packaging containing liquid, for a first preferred embodiment of the invention shown in FIGS. 1.1 and 1.2.

FIG. 2B.- Shows an exploded view of a tap for packaging containing liquid, for the variant of the first preferred embodiment of the invention shown in FIGS. 1.3 and 1.4.

FIGS. 3.1 and 3.2.- Show top and bottom perspective views, respectively, of a tap for packaging containing liquid, for a second preferred embodiment of the invention.

FIGS. 3.3 and 3.4.- Show top and bottom perspective views, respectively, of a tap for packaging containing liquid, for a variant of the second preferred embodiment of the invention.

FIG. 4A.- Shows an exploded view of a tap for packaging containing liquid, for a second preferred embodiment of the invention shown in FIGS. 3.1 and 3.2.

FIG. 4B.- Shows an exploded view of a tap for packaging containing liquid, for the variant of the second preferred embodiment of the invention shown in FIGS. 3.3 and 3.4.

FIGS. 5.1 and 5.2.- Show perspective views before and after the positioning of a reinforcement plate for a tap for packaging containing liquid, for a second preferred embodiment of the invention.

FIGS. 6.1 and 6.2.- Show top and bottom perspective views, respectively, of a tap for packaging containing liquid, for a third preferred embodiment of the invention.

FIG. 7.- Shows an exploded view of a tap for packaging containing liquid, for a third preferred embodiment of the invention.

### DETAILED DESCRIPTION

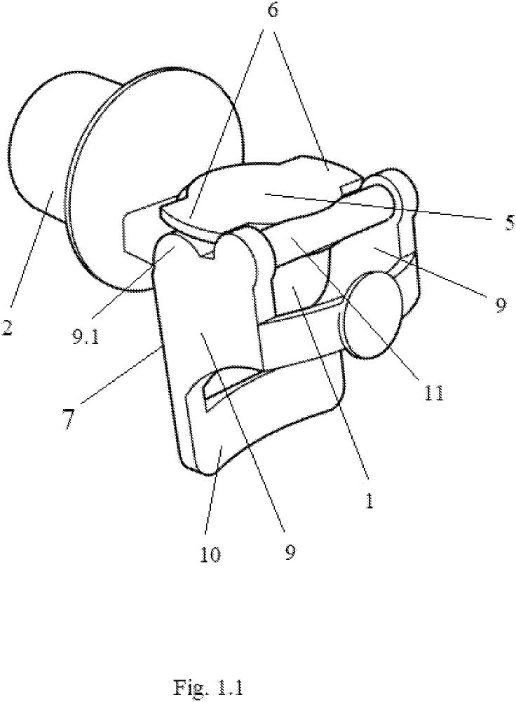

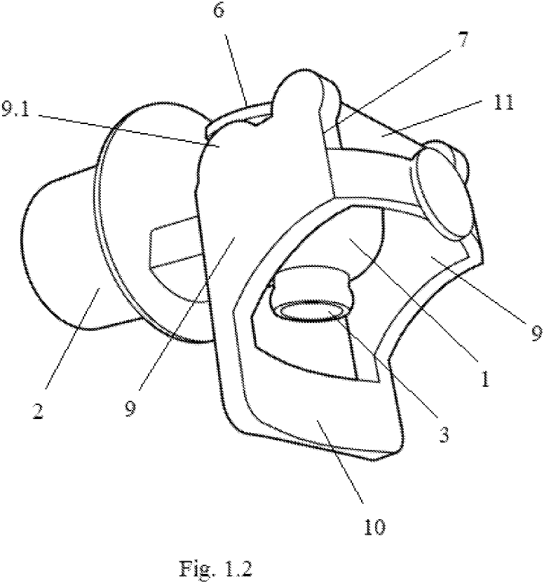

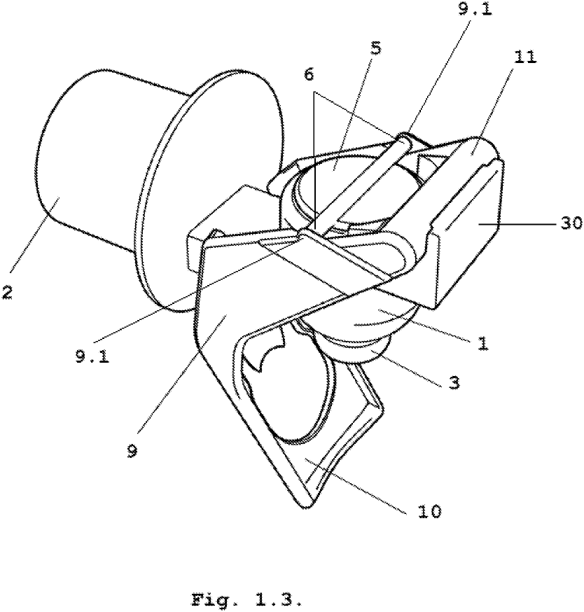

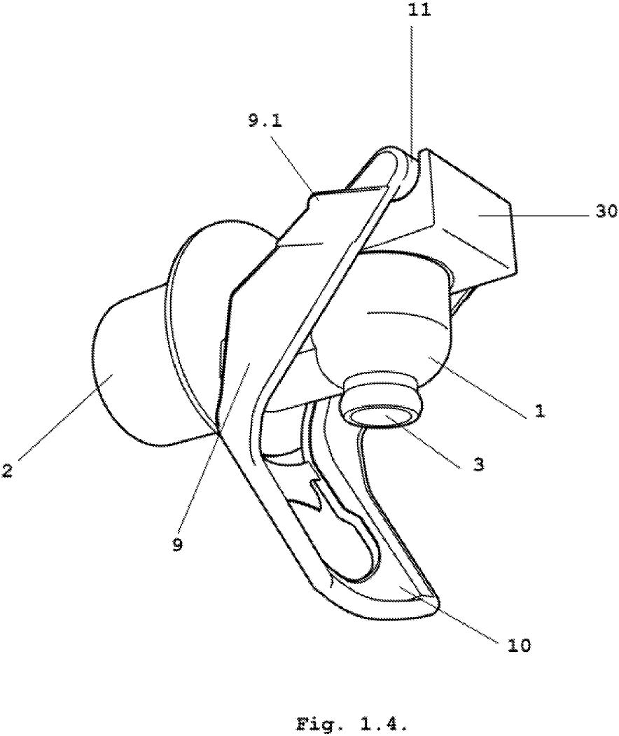

In light of the figures provided, it can be seen how, in a first preferred embodiment of the invention shown in FIGS. 1.1, 1,2 and 2A, the tap for packaging containing liquid, formed by a box and a containment bag situated therein proposed here, comprises a body (1) with a connection (2) to the bag and an outlet mouth (3) to the exterior in the bottom region thereof, with a patch (not shown in the figures) for closing the outlet mouth (3) therein and a spring (4) connected to the patch, and an opening device (5) with lateral fins (6) connected to the patch.

This tap comprises means for actuating the fins (6) of the opening device (5), which comprise a lever part (7) and a connection element (8) for connecting same to the body of the tap.

As shown in FIGS. 1.1 and 1.2, the lever part (7) comprises two side pieces (9) situated on both sides of the outlet mouth (3) and a bottom end (10) arranged between said outlet mouth (3) and the packaging, with an elevation which is lower than or below that of the outlet mouth (3). Therefore, in a closure position of the tap in which the patch is fitted in the outlet mouth (3) thereof, each side piece (9) has a top end (9.1) close to one of the fins (6), and the bottom end (10) is at a certain horizontal separation distance with respect to the packaging.

Moreover, the connection element (8) for connecting the lever part (7) to the body (1) of the tap is attached to said body (1) and comprises coupling means for coupling to both side pieces (9) of the lever part (1).

These coupling means form a tilting shaft for tilting this lever part (7) from the closure position of the tap to an opening position thereof, in which the horizontal separation distance of the bottom end (10) of the lever part (7) with respect to the packaging is less than in the closure position and the top end (9.1) of the side pieces (9) thereof is in contact with the corresponding fin (6), wherein these fins (6) have an elevation which is greater than that which they have in the closure position.

Consequently, when the bottom end (10) of the lever part (7) is pushed horizontally by means of the very container that is intended to be filled with liquid, held with the only hand that is involved in the process, the lever part (7) tilts about the tilting shaft such that the bottom end (10) thereof moves closer to the packaging, while the top end (9.1) of the side pieces pushes the fins (6) upwards.

This lifting of the fins (6) causes the closure patch to be raised, removing it from the outlet mouth (3) and thereby allowing the flow to pass. When the horizontal pushing force stops, the elastic force of the spring (4) closes the tap again, making the patch and the fins (6) descend.

In this first preferred embodiment of the invention, as shown in FIGS. 1.1, 1.2 and 2A, the coupling means are formed by a longitudinal shaft (11), which acts as a tilting shaft and is attached at its central point to the outer contour of the connection element (8), and the side pieces (9) of the lever part (7) comprise cavities (12) for engagement of the ends of the longitudinal shaft (11).

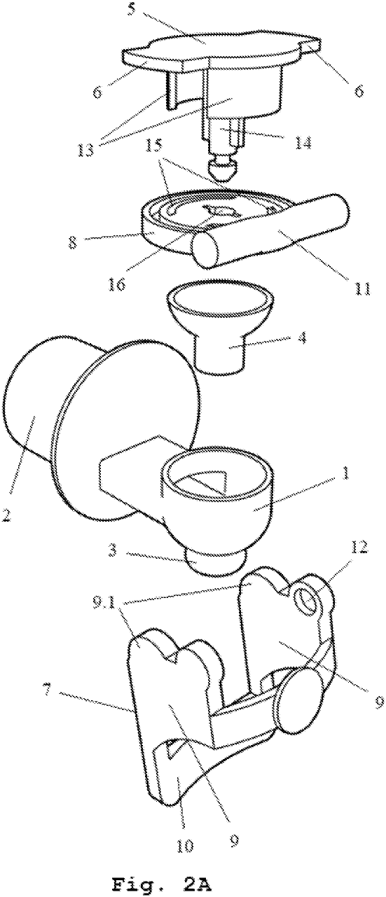

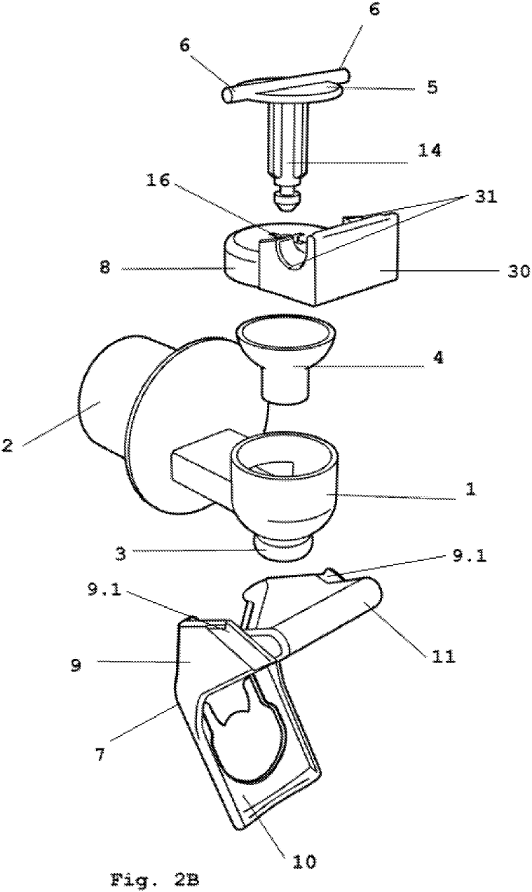

As can be seen in FIG. 2A, in this first preferred embodiment, the opening device (5) is situated on the connection element (8) and comprises two linking flanges (13) and a connection rod (14) for connection to the patch, which emerge from the bottom surface thereof. The rod (14) has a cylindrical shape and is provided with two fins that project in a diametrically opposing manner and at the end has a harpoon-like configuration so as to facilitate said connection to the patch.

For its part, the connection element (8) in this case comprises two first grooves (15) configured for the tight passage of a corresponding linking flange (13) and a central opening (16) for the passage of the connection rod (14), an opening which has the same configuration as the rod (14), that is to say it is a cylindrical space with two diametrically opposed grooves.

FIGS. 1.3, 1.4 and 2B show a variant of this first embodiment. As can be seen, the main difference is that the longitudinal shaft (11), which acts as the tilting shaft, is in this case attached between the side pieces (9) of the lever part (7). The connection element (8) in this variant comprises a housing (30) provided with an open circular opening (31), so as to house the longitudinal shaft (11) and to allow same to rotate. By means of simple pressure, the longitudinal shaft (11) is inserted and remains removably attached in said housing (30), having freedom of rotation in both directions.

The closure element (8) has a central opening (16) for the passage of the connection rod (14), an opening (16) which has the same configuration as the rod (14), that is to say a cylindrical space with two diametrically opposed grooves.

In this variant embodiment, the lateral fins (6) of the opening device (5) have a cylindrical configuration adjoining the flat upper face of the opening device (5) and project slightly therefrom. The end of these lateral fins (6) are located in this variant in a recess practiced inside the top end (9.1) of the side pieces (9).

In the same way as in the first embodiment, in this variant when the bottom end (10) of the lever part (7) is pushed horizontally by means of the very container that is intended to be filled with liquid, the lever part (7) tilts around the tilting shaft such that the bottom end (10) thereof moves closer to the packaging, while the top end (9.1) of the side pieces (9) pushes the fins (6) upwards.

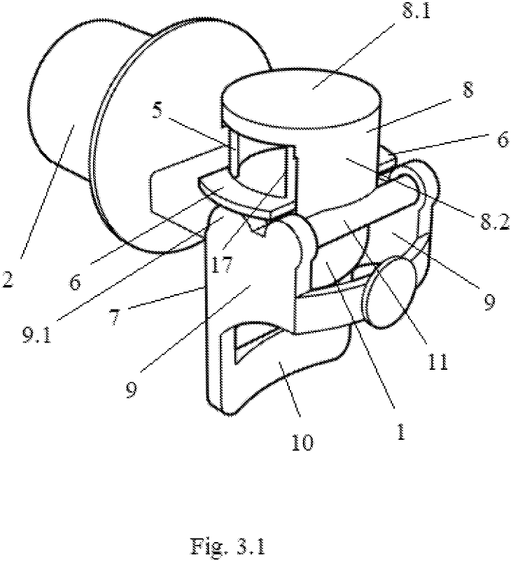

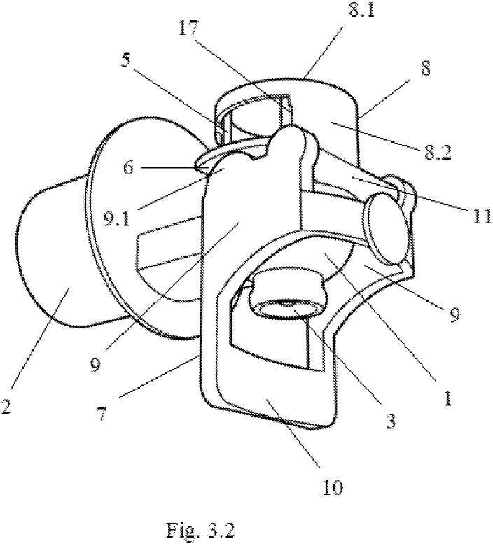

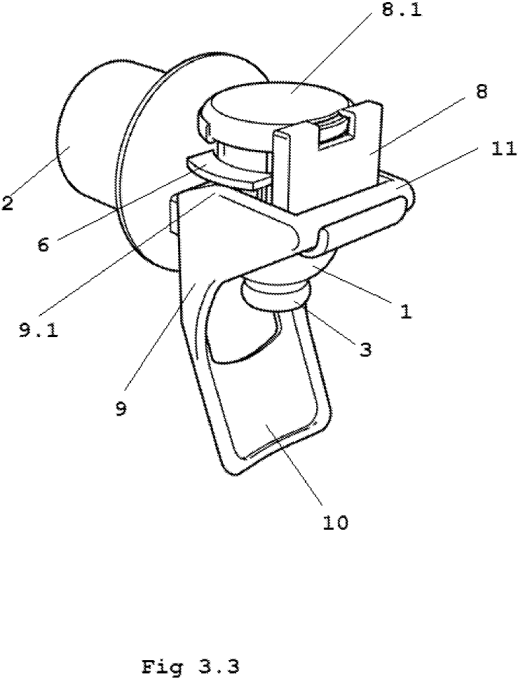

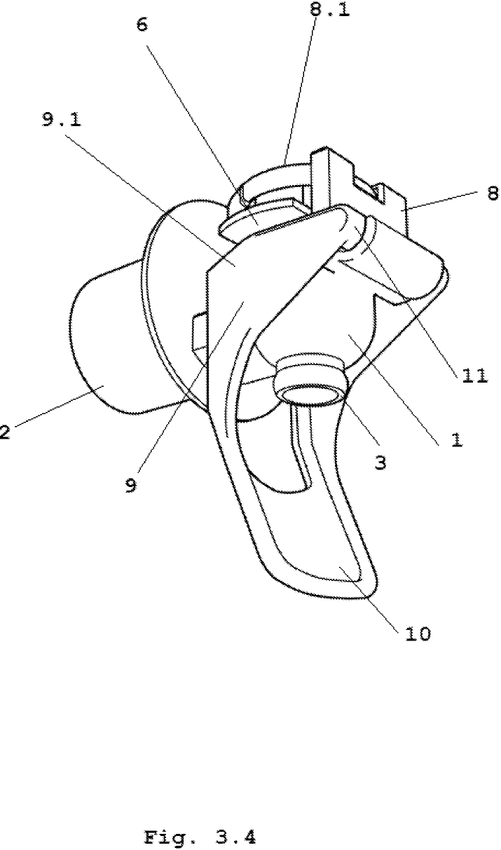

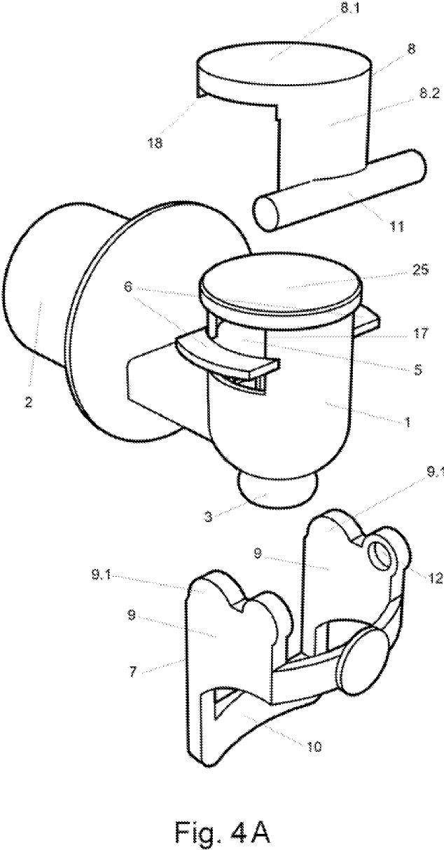

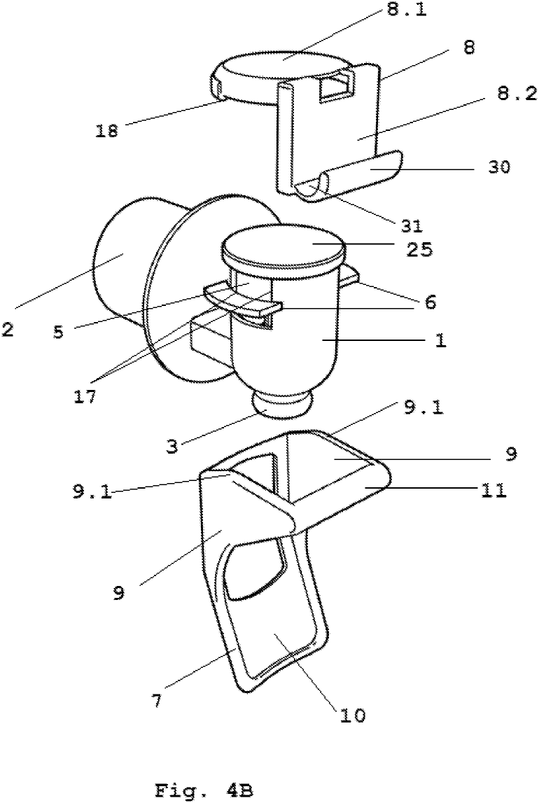

In other preferred embodiments of the invention, such as a second embodiment shown in FIGS. 3.1, 3.2 and 4A, the opening device (5) is situated between the body (1) of the tap and the connection element (8).

This case involves an adaptation of the actuation means to an existing tap for this type of packaging, and therefore the lever part (7) and the connection element (8) comprise measures adapted to the dimensions of the body (1) of the tap.

The objective in this case is therefore to provide an existing tap with additional means which couple to the existing tap, such that when the lever part (7) is pushed by a glass or container in a horizontal direction, the result is the same as in the first embodiment proposed above.

Consequently, in this second embodiment, the body (1) of the tap comprises, in a region close to the top end, lateral guides (17) for sliding the fins (6) of the opening device (5), and the connection element (8) comprises a top base (8.1) with one or more flanges for attachment (18) to the cover (25) arranged on the top end of the body (1) of the tap. Thanks to these flanges (18) for attachment to the cover (25), the connection element (8) is rigidly connected to the existing tap. Also provided is a lateral surface (8.2) which emerges perpendicularly from the front contour of the top base (8.1), configured to be coupled to the outer surface of the body (1) of the tap.

In this case, the longitudinal shaft which forms the tilting shaft is attached precisely to the free end of this lateral surface (8.2).

Just like in the first embodiment described above, in this second embodiment too the lever part (7) comprises two side pieces (9) situated on both sides of the outlet mouth (3) and a bottom end (10) arranged between said outlet mouth (3) and the packaging, with an elevation which is lower than or below that of the outlet mouth (3). The side pieces (9) of the lever part (7) comprise cavities (12) for engagement of the ends of the longitudinal shaft (11), allowing said shaft to rotate.

Also in this second embodiment, when the bottom end (10) of the lever part (7) is pushed horizontally by means of the very container that is intended to be filled with liquid, held with the only hand that is involved in the process, the lever part (7) tilts about the tilting shaft such that the bottom end (10) thereof moves closer to the packaging, while the top end (9.1) of the side pieces pushes the fins (6) of the existing tap upwards.

This lifting of the fins (6) causes the closure patch to be raised, removing it from the outlet mouth (3) and thereby allowing the flow to pass. When the horizontal pushing force stops, the elastic force of the spring (4) closes the tap again, making the patch and the fins (6) descend. FIGS. 3.3, 3.4 and 4B show a variant of this second embodiment. As can be seen, the main difference is that the longitudinal shaft (11), which acts as the tilting shaft, is in this case attached between the side pieces (9) of the lever part (7).

The lateral surface (8.2) which emerges perpendicularly from the front contour of the top base (8.1) of the connection element (8), in this case finishes with a circular housing (30) having an open circular opening (31) and is configured to house the longitudinal shaft (11) and to allow same to rotate. By means of simple pressure, the longitudinal shaft (11) is inserted and remains removably attached in said housing (30) provided with an open circular opening (31), having freedom of rotation in both directions.

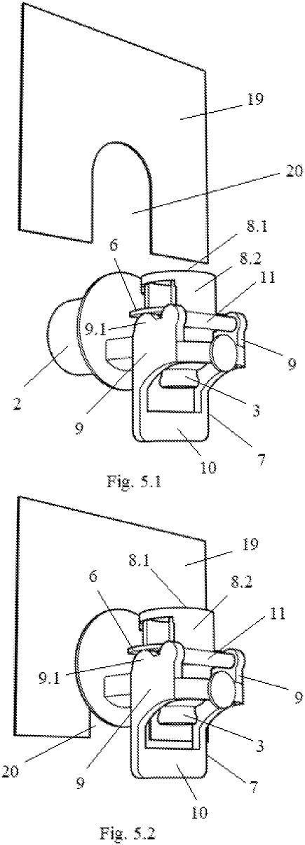

FIGS. 5.1 and 5.2 show a perspective view of this second embodiment, also incorporating an additional part consisting of a reinforcement plate (19) for reinforcing the packaging. This reinforcement plate (19) has a shape that is fitted to the neck of the connection (2) of the body (1) to the bag. As can be seen in FIGS. 5.1 and 5.2, this reinforcement (19) is formed by a rigid plate arranged on the outer surface of the box of the packaging, and has a central groove (20) that is open on one side, such that it can engage around the neck of the connection (2) of the body (1) of the tap to the bag. The reinforcement plate (19) is therefore situated between the cardboard of the packaging and the raised transverse surface of the actual neck of the connection (2).

The main objective of this reinforcement (19) is to protect the cardboard packaging since, when a horizontal force is exerted so as to tilt the lever part (7), a perforation could be made in the cardboard packaging due to an excessive force being used. Thanks to this reinforcement plate, the horizontal pressure on the cardboard is distributed over a larger rigid surface, thereby eliminating this risk.

This reinforcement plate (19) can also be used in the other first and third embodiments described in the present invention.

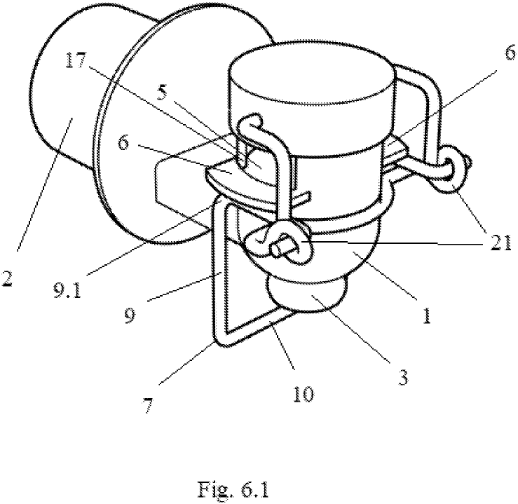

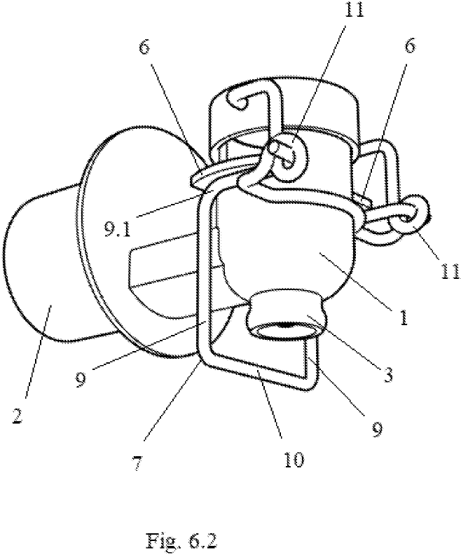

FIGS. 6.1, 6.2 and 7 show a third preferred embodiment of the invention, also consisting of an adaptation of the actuation means to an existing tap for this type of packaging. Also in this case, the objective is to provide an existing tap with additional means that are coupled to the existing tap, such that when a lever part is pushed horizontally by a glass or container in the horizontal direction, opening of the tap is obtained.

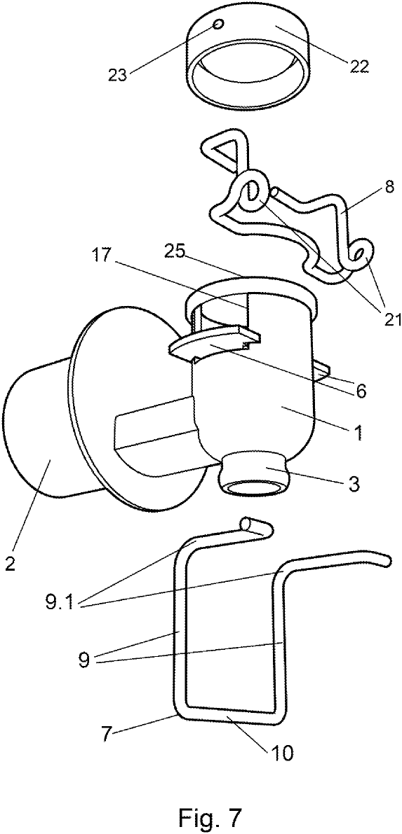

In this third embodiment, both the lever part (7) and the connection element (8) are formed by respective curved wires. As shown in FIG. 7, the lever part (7) is formed wholly by a wire which, starting from a bottom end (10), extends perpendicularly on two side pieces (9) which have respective top ends (9.1) in contact with the corresponding fins (6) of the existing tap. The means for coupling to the side pieces (9) of the lever part (7) are formed by curved folds (21) of the connection element (8) which are suitable for engagement of the ends of the lever part (7). It is precisely these ends of the lever part (7), fitted in the curved folds (21), that form the tilting shaft of the lever part (7) in this third embodiment.

Furthermore, in this case, the body (1) of the tap comprises, in a region close to the top end, lateral guides (17) for sliding the fins (6) of the opening device (5), and the connection element (8) comprises an adjustment part (22) for fitting to the cover (25) arranged on the top end of the body (1) of the tap, which comprises holes (23) for coupling of the ends of the connection element (8).

The described embodiments only constitute examples of the present invention and therefore the specific details, terms and phrases used in this specification must not be regarded as being limiting, but rather have to be understood only as a basis for the claims and as a representative basis that provides an understandable description, as well as sufficient information for a person skilled in the art to apply the present invention.

1. A tap for packaging containing liquid, formed by a box and a containment bag situated therein, comprising a body with a connection to the bag and an outlet mouth to the exterior in the bottom region thereof, and the interior of which comprises a tightly fitting patch for closing the outlet mouth and an elastic spring connected to the patch, and an opening device with lateral fins connected to the patch, comprising a means for actuating the fins of the opening device, which comprise
a lever part, comprising two side pieces situated on both sides of the outlet mouth and a bottom end arranged between said outlet mouth and the packaging, the elevation of the bottom end being below the elevation of the outlet mouth, such that, in a closure position of the tap in which the patch is engaged in the outlet mouth thereof, each side piece has a top end close to a respective fin, and the bottom end has a horizontal separation distance with respect to the packaging, and;
a connection element for connecting the lever part to the body of the tap, attached to the body and comprising coupling means located between the two side pieces of the lever part, such that they form a tilting shaft for tilting this lever part from the closure position of the tap to an opening position of the tap, wherein the horizontal separation distance of the bottom end of the lever part with respect to the packaging is less than in the closure position;
wherein the tilting of the lever part causes the vertical displacement of the top ends of the side pieces, which in turn vertically displace the fins, causing the tap to open by removing the patch with respect to the outlet mouth.

2. The tap for packaging containing liquid according to claim 1, wherein the coupling means are formed by a longitudinal shaft attached at its central point to the outer contour of the connection element, and the side pieces of the lever part have cavities for engagement with the ends of the longitudinal shaft .

3. The tap for packaging containing liquid according to claim 1, wherein the coupling means are formed by a fixed longitudinal shaft and the side pieces of the lever part, and the connection element comprises, attached to the outer contour thereof, a housing having an open circular opening configured to removably attach the longitudinal shaft and to allow same to rotate.

4. The tap for packaging containing liquid according to claim 2, wherein the opening device is situated on the connection element and comprises one or more linking flanges and a connection rod for connection to the patch, which emerge from the bottom surface thereof and the connection element comprises one or more first grooves adjusted for the passage of a corresponding linking flange and an opening adjusted for the passage of the connection rod.

5. The tap for packaging containing liquid according to claim 3, wherein the opening device is situated on the connection element and comprises a connection rod for connection to the patch, which emerges from the bottom surface thereof, and the connection element comprises an opening adjusted for the passage of the connection rod.

6. The tap for packaging containing liquid according to claim 2, wherein the opening device is situated between the body of the tap and the connection element, and the body of the tap and comprises, in a region close to the top end, lateral guides for sliding the fins of the opening device, wherein the connection element comprises a top base with one or more attachment flanges for attachment to the cover arranged at the top end of the body of the tap and a lateral surface which emerges perpendicularly from the front contour of the top base, suitable for being coupled to the outer surface of the body of the tap, and the longitudinal shaft or the housing for said longitudinal shaft is attached to a free end of this lateral surface.

7. The tap for packaging containing liquid according to claim 1, wherein the lever part and the connection element are formed by wires, wherein the means for coupling to the side pieces of the lever part are formed by curved folds of the connection element suitable for engagement of the ends of the lever element.

8. The tap for packaging containing liquid according to claim 7, wherein the body of the tap comprises, in a region close to the top end, lateral guides for sliding the fins of the opening device, and the connection element comprises an adjustment part for fitting to the cover arranged on the top end of the body of the tap, which comprises holes for coupling of the ends of the connection element.

9. The tap for packaging containing liquid according to claim 1, comprising a reinforcement for the packaging formed by a rigid plate arranged on the outer surface of the box of the packaging, wherein the plate has a central groove that is open at one side, such that it can engage around the neck of the connection of the tap to the bag.
